(19) United States
(12) Patent Application Publication
(10) Pub. No.: US 2002/0131534 A1
(43) Pub. Date: Sep. 19, 2002

(54) System and method for multistage interference cancellation

(76) Inventors: Masayuki Ariyoshi, Tokyo (JP); Tetsufumi Shima, Yokosuka (JP); Koichi Kojima, Yokosuka (JP); Riaz Esmailzadeh, Yokohama (JP); Jonas Karlsson, Yokohama (JP); Jeonghoon Han, Yokosuka-shi (JP)

Correspondence Address: Raymond Van Dyke, Esq., Jenkens & Gilchrist, P.C., 3200 Fountain Place, 1445 Ross Avenue, Dallas, TX, 75202-2799, US

(21) Appl. No.: 09/779,020

(22) Filed: Feb. 7, 2001

(51) Int. Cl. H04K 1/00

(52) U.S. Cl. 375/346

(57) ABSTRACT

In a multi-access communications network, an interference cancellation (IC) method is used to reduce the interference between users and help increase the capacity of the network. A window is used in the IC method to cancel the interference on a user signal from other user signals within the window. The window then slides to process a different part of the user signals. This window slide may be accomplished using a full or a partial slide of the window. The present invention achieves a very small delay for the interference cancellation of user signals using a multi-stage interference cancellation method.

### BACKGROUND OF THE PRESENT INVENTION

1. Field of the Invention

The present invention relates generally to a multistage interference cancellation technique using a sliding window.

2. Background of the Present Invention

In a CDMA system, a user signal is spread with a wide frequency bandwidth by the use of an individual code and is transmitted in a common frequency band. The receiver detects a desired signal by a despreading process from the CDMA signal and the individual code. The spreading codes used for a CDMA system are chosen to have a relatively low cross-correlation between any two sequences in the set. However, interference nonetheless occurs in the CDMA system due to cross correlation among the spreading codes assigned to users. Unlike other multiple access wireless communication methods, CDMA interference is mainly from other users within the same cell, rather than users in other cells.

CDMA based systems have a soft capacity, meaning that there is no limit to the number of users on the network. However, an increase in the number of users may cause a degradation in the quality of service of the links, in view of the above mentioned cross correlation factor. A major factor limiting user capacity of CDMA systems is the interference from other users in the system. Thus, CDMA user capacity can be increased if the multiuser interference is canceled.

FIG. 1 illustrates a standard uplink transmission frame structure, sometimes called the reverse link, in an IMT-2000 or other CDMA-based system. This uplink frame structure is designed on an Inphase/Quadrate (I/Q) basis where the control information 10, such as the power control 14, rate information 12, referred to in the WCDMA standard as the Transport Format Combination Indicator (TFCI), and the pilot symbols 16 are transmitted on the Q-channel. This part of the uplink channel is designated as the dedicated physical control channel (DPCCH) 10. The data part 20 is transmitted over the I channel which is designated as the dedicated physical data channel (DPDCH) 20. The control channel (DPCCH) 22 is divided into fifteen slots. Each of the fifteen slots 24 consists of ten symbols, of which two symbols convey information about the DPDCH such as transmission rate and repetition or puncturing patterns. This information must be detected first before the interference cancellation processing of the DPDCH is carried out.

FIG. 2 illustrates the symbols received at the base station in a multi-user single-rate system. In this figure, for example, signals from three users H1, H2 and H3, arrive at the receiver asynchronously, meaning that the received symbols are not synchronized with each other. This asynchronous relationship is due to various factors, such as the difference in distance between each user and the base station. As seen in FIG. 2, symbol 1 (32) for user H1 (30) arrives at the base station before symbol 1 (42, 52) for both users H2 (40) and H3 (50). However, symbol 1 (42, 52) of both users H2 40 and H3 50 cause interference on the received symbol 1 (32) of user H1 30. In order to cancel this interference, the receiver has to wait for both symbols to be received, undesirably delaying the interference cancellation (IC) process performed to reduce the interference from other users in the system. In a multi-stage IC process, this delay is further increased. The interference cancellation (IC) process is performed by canceling the effect of all user signals on the desired signal. As an example, this IC process could be done by subtracting the signals of the other users from the desired signal. Before this subtraction each signal of the other users could be multiplied by a factor determined by the level of interference imposed on the desired signal.

FIG. 3 illustrates the symbols received at the base station in a multi-user multi-rate system. In this system, every user could transmit symbols of various length and rate. The same principle of the interference caused by other user symbols applies, e.g. symbol 2 (64) of user H1 (60) may include interference from symbols 1 (72) and 2 (74) from user H2 (70), symbols 1 (82) and 2 (84) from user H3 (80), symbol 1 (92) from user M1 (90) and symbol 1 (98) from user L1 (96). Accordingly, these symbols must be received in order to perform an IC process for symbol 2 (64) of the signal from user H1 (60). The delay is even greater than the delay for single rate systems. The maximum delay in a multi-rate system using a multi-stage serial interference cancellation method can be expressed by:

$$Δ = {N}_{stages} \cdot {\sum }_{i + 1}^{{N}_{users}} {T}_{s , i}$$

where N_{stages} is the number of cancellation stages, Nᵤₛₑᵣₛ is the number of users in the IC process, and T_{s,i} is the symbol length for user i. Similar results can be obtained for a multi-stage parallel interference cancellation (MSPIC) method.

As can be seen, conventional multi-stage IC techniques which operate at the symbol level cause excessive delays.

The implementation of interference cancellation (IC) techniques in the past have been hampered by excessive processing delays necessary to carry out the cancellation operation. The delay can be especially significant for real-time operations such as voice/video phone communications. The delay can also significantly affect the retrieval and application of control commands such as power control or frame-rate information.

Some of the previous approaches to deal with multiuser interference problems include using an optimum multiuser demodulator with a maximum likelihood detection scheme assuming symbol-synchronous transmission. The assumption of a synchronous transmission is unrealistic due to the varying distance between users and a base station, as described herein. Another approach used a serial IC wherein the user with the highest Signal to Interference Ratio (SIR) is detected, and the interference corresponding thereto is removed from the received signal. This process continues until all users' signals have been detected.

Yet another approach implemented a cascaded IC technique where the discrete results of the hard data decisions of each stage of demodulation are fed back to reduce interfering signals. This is performed to obtain better estimates of the transmitted data. Still another approach utilized a serial IC technique assisted by the pilot signal. Further, another approach used orthogonalized signature sequences to improve the successive serial cancellation.

What is needed then is a method and apparatus for performing interference cancellation operations in a more timely manner. Having a highly reliable cancellation process and maintaining a small delay in the multi-stage process.

### SUMMARY OF THE INVENTION

The present invention is directed to canceling the interference from other users in a system by the use of a window. According to a first embodiment of the present invention, a multistage interference cancellation (IC) technique is carried out over signals within the window. Only the signal portions within the window for all users are used in the IC process. The window slides by a full window length after the IC process is performed on the signal portions within the window.

A second embodiment of the present invention stipulates that after each stage of the IC process, the window slides forward by a fraction of the window length.

The operation may optionally detect symbols that are incomplete at the end of the window before performing the IC process. In this way, the reliability of the symbol detection process is enhanced.

The embodiments of the present invention advantageously remove the dependence of the maximum delay on the number of interfering signals and the number of stages, which reduces the overall delay in the IC process significantly.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 illustrates conventional uplink transmission frame structure corresponding to CDMA-based communication;

FIG. 2 illustrates symbols received at a base station in a multi-access single rate system;

FIG. 3 illustrates symbols received at a base station in a multi-access multi-rate system;

FIG. 4 is a block diagram of a base station for a wireless communication network according to an embodiment of the present invention;

FIG. 5 illustrates the symbols received at a base station in a multi-rate system employing the sliding window approach according to the first embodiment of the present invention;

FIG. 6 illustrate the flow chart for the method according to the first embodiment of the present invention;

FIG. 7 illustrates the symbols received at a base station in a multi-rate system employing the fractional sliding window approach according to the second embodiment of the present invention; and

FIG. 8 illustrate the flow chart for the method according to the second embodiment of the present invention.

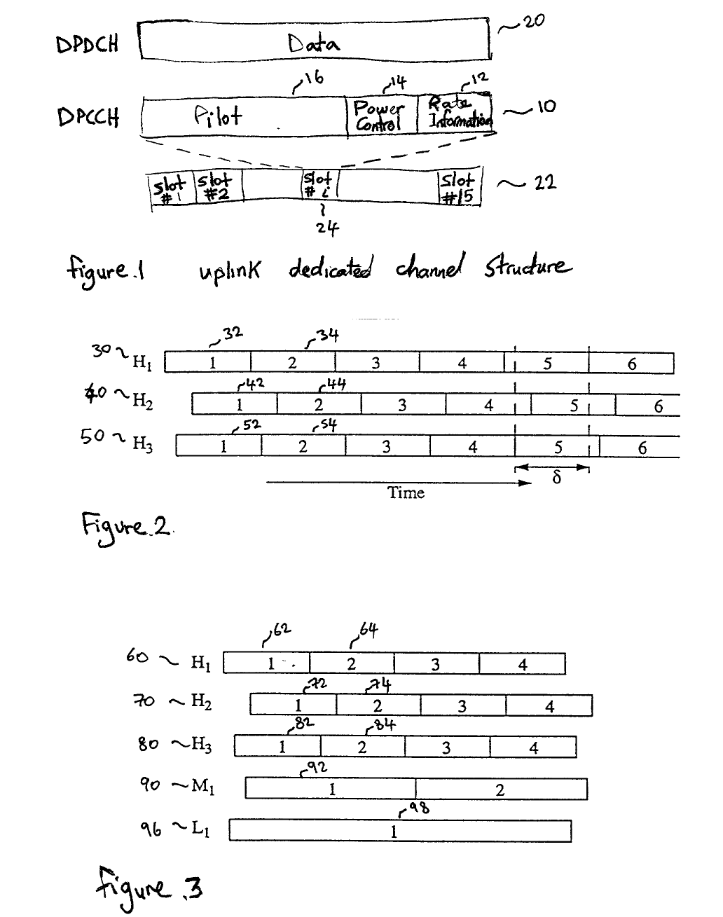

### DETAILED DESCRIPTION OF THE PRESENTLY PREFERRED EXEMPLARY EMBODIMENTS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

It is the object of the invention to provide a method to cancel the interference between users in a multiple access system using a sliding window. Users referred to herein are mobile stations operating in a wireless telecommunication network, but generally users may be any access device, such as a fixed wireless transmitter, a personal data assistant (PDA) device, a wireless modem, etc., utilizing shared resources in wireless systems such as CDMA-based networks. Multi-stage serial interference cancellation (MSSIC) or multi-stage parallel interference cancellation (MSPIC) is carried over a window. This window is set to a size determined by the system (e.g. base station).

The window size could be varied for each IC process. Generally, in a multi-stage IC system, the window size could be modified in a manner determined by the system. However, the window size could also be of a constant length, also determined by the system.

In a preferred embodiment of the present invention, the window size could be measured in chips or any other unit of reference. This increases the accuracy of the IC process, as will be shown hereinafter. User signals within the window are processed. At each cancellation stage, the same interval for all users involved in the process is considered. This avoids any excessive delays caused by waiting for all symbols to be received in order to perform an interference cancellation on each symbol. The present invention on the other hand, is only concerned with a portion of a symbol of a user signal within the window.

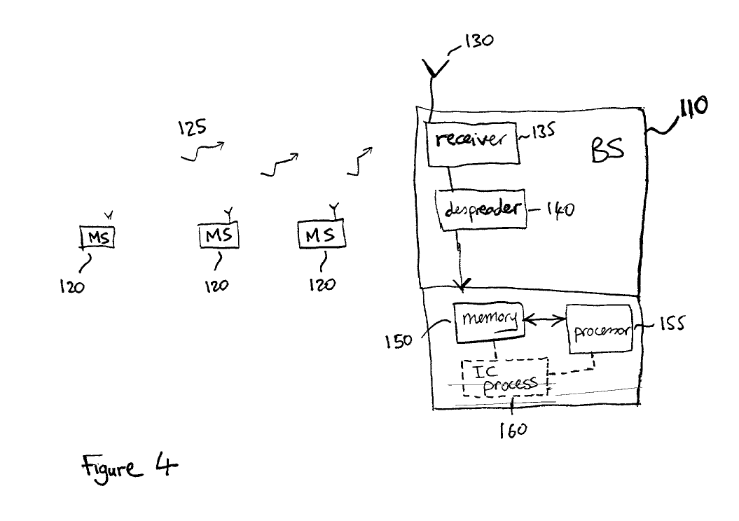

FIG. 4 illustrates a base station 110 which receives mobile station 120 signals 125. An antenna 130 receives these signals and sends the signals to a receiver 135 connected to the antenna 130. The receiver then despreads 140 the received signal for each user using each user's 125 unique despreading code. Each user's signal 125 received by the receiver 135 is stored in a buffer (memory) 150. All user signals within the buffer are formed into several signal data streams, each for a different user. Connected to this buffer is a processor 155 that performs the IC process 160 on the data/signals stored in the buffers. The memory 150 may also store instructions for performing the IC process 160 on the signal data streams, as described in detail below. It should however be understood by one of ordinary skills in the art that the IC process, referred to in the present invention, could be implemented in software running on a processor as mentioned hereinabove, being embedded in hardware, or using any other means to perform the functions described hereinafter.

In the embodiments described hereinafter, a window is applied to data residing in a buffer. The applying of a window to the data represents taking into account the portion of the data within a determined time period or window limit. The data within the determined time limit/period is used in the IC process, as described in detail hereinafter.

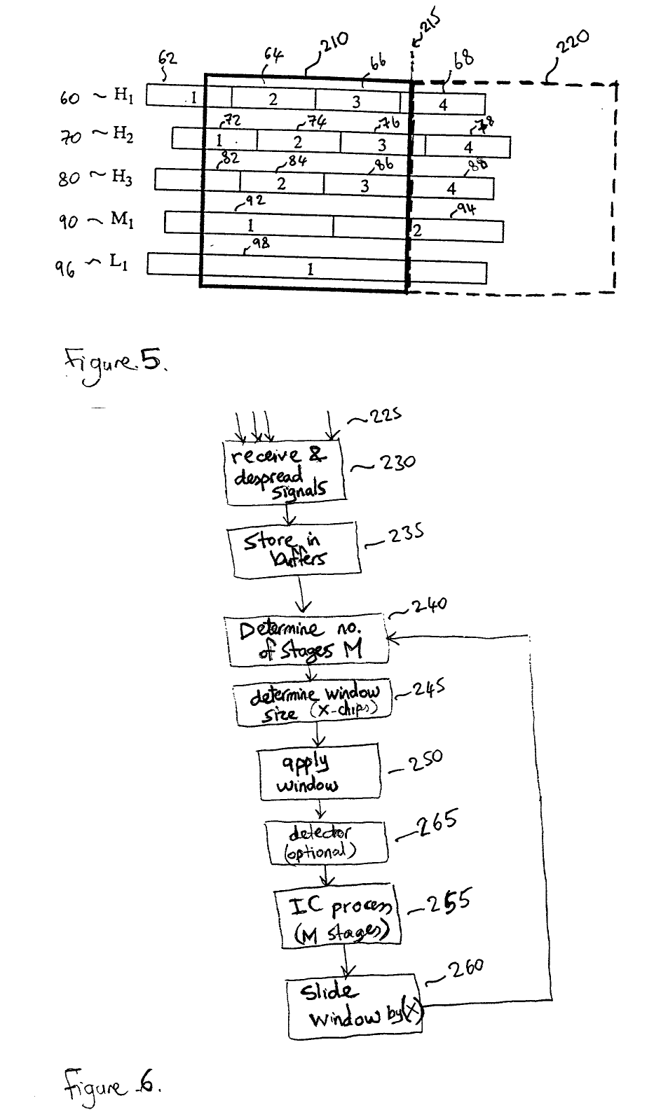

FIG. 5 illustrates the symbols received at the base station in a multi-user multi-rate system and the application of a sliding window to those symbols. The window 210 is applied to the received symbols and only those symbol portions falling within the window limits are used for the IC process. After performing an IC procedure only on those symbol portions falling within the window limits by the number of stages required, the window slides or is shifted to process the symbol portions falling within the time period defined by the shifted window 220 (shown in dashed lines). In a first embodiment of the present invention, the end of a window 215 is used to define the beginning of the next window following a shift thereof.

FIG. 6 illustrates an IC operation of a base station according to a first embodiment of the present invention. In this embodiment, the despread mobile stations signals received 230 are put in buffers 235, each buffer representing a different mobile station despread signal. The system determines the number of stages 240 that need to be performed according to the severity of the interference in that system. The more the interference, the more IC process stages need to be performed. If, however, the interference is the same all of the time, the number of stages may be constant. The determination of a fixed number of stages may in this case be done at the setup phase. Otherwise, the system (e.g. base station) determines the stages M (240) used before the IC process. The window size to be used is then determined 245. This window size may be measured in chip size length (x-chips length) or any accurate measurement length. The window size could be varied after the number of stages is complete and before the IC process is performed on the symbols within the shifted window. However, the window size may stay constant, in this case the system may determine the window length in the setup phase. The window having the determined size is applied to the data/signal 250 in the data buffers. Only the portion of the data within this window is utilized in the IC process. The IC process 255 processes the data within the window limit. The accuracy of the window is to the chip length. After the first stage of the IC process, the same despread mobile stations signals are being processed again, that is if there is more than one stage. The following stages, if any, are performed in exactly the same way as the first stage. After all the stages are finished, the window slides or is shifted 260 to process the next set of symbol/signal portions in the buffers that are associated with the time period encompassed by the shifted window 220.

The operation may optionally include a detection step 265 after applying the window 250 to the despread mobile station signals in the buffers. The detector 265 determines the incomplete symbols at the end of the window 215. In a preferred embodiment, the detector determines those symbols at the beginning and at the end of the window. Those determined symbols are optionally included in the IC process. In this way, at least some of the symbols that are partially in the window limits (e.g. 68, 76, 86, 62, 72, 82) are used fully in the IC process for that window.

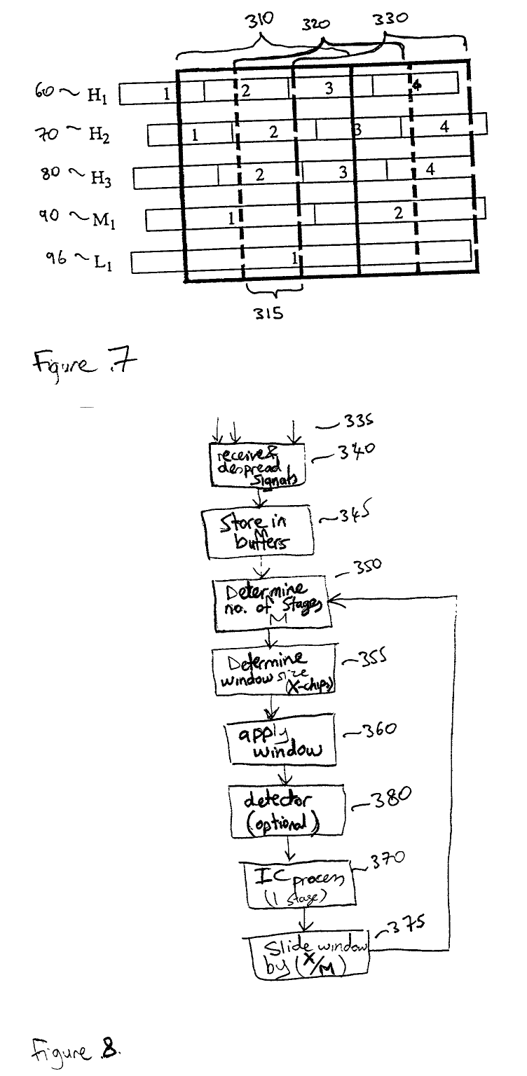

FIG. 7 illustrates the symbols received at the base station in a multi-user multi-rate system and the application of a partially sliding window to those symbols. The window 310 is applied to the received symbols and only those symbol portions falling within the window 310 are used in the IC process. After performing an IC process on those symbol portions falling within the window, the window slides or is shifted partially 320 to process the symbol portions falling within the time period defined by the shifted window. In a second embodiment of the present invention, the length of the window 310 and the number of stages used define the partial sliding of the next window. After each stage, the window 310 slides by a certain length 315 that is proportional to the window length and inversely proportional to the number of stages used, e.g. the window slides by 1/M of the length of the window if the multistage IC process consists of M stages.

FIG. 8 illustrates an operation of the base station according to a second embodiment of the present invention. Specifically, after the users' signals 335 are received and despread 340, they are stored in buffers (memory) 345 as in the first embodiment. The number of stages 350 and the window size (X-chips) 355 are also determined as in the first embodiment. The window 310 is applied to the despread users' signals in the buffers. Only the portion inside this window 310 is utilized in the IC process. After the IC process is complete in the first stage, the window slides or is shifted partially by a length 315 inversely proportional to the number of stages used in the cancellation process, e.g. the window slides by ⅓ of the length of the window if the multistage IC process consists of three stages. The window keeps sliding forward by the determined shift amount after each stage. It should be understood that the length of the window could vary from one stage to the next or be fixed. Also, the number of stages could change from one set of stages to the next as determined by the system.

The operation may optionally include a detection step 380 after applying the window 360 to the despread mobile station signals in the buffers. The detector 380 determines the incomplete symbols at the end of the window. In a preferred embodiment, the detector determines those symbols at the beginning and at the end of the window. These determined symbols are optionally included in the IC process. In this way, at least some of the symbols that are partially within the window limits are used fully in the IC process for that window, hence reducing the interference effect by those symbols.

It should be understood that other embodiments may be implemented. The uplink communication between the mobile stations and the base station, described above could be applied to the downlink communication as well. In this case, a mobile station will include all the components described in the base station for the functionality of the interference cancellation (IC) process. The embodiments described hereinabove refer to a serial multistage IC process, however, it should be understood that the multistage IC process may also be a parallel multistage IC process.

The above described embodiments may also be applied to any multi-access system where there are multiple users on a network sharing the same resources, e.g. CDMA, WCDMA, cdma2000, etc. In a preferred embodiment of the present invention, the multi-stage interference cancellation process may be applied to multi-rate systems.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. An interference cancellation (IC) method comprising the steps of:
receiving signals from at least two users, said received signals forming respective signal data streams; and
performing an interference cancellation (IC) process on a given portion of each of said signal data streams, each said given portion being within a common window, whereby respective interference between each of said respective data streams is minimized.

2. The method according to claim 1, further comprising, upon completion of said performing step, the step of shifting said common window to another portion of said signal data streams.

3. The method according to claim 2, wherein said common window has a given window size, said method further comprising the step of modifying, after said step of shifting, said given window size.

4. The method according to claim 2, wherein said step of shifting further comprises the step of:
shifting said common window by a full window length.

5. The method according to claim 2, wherein said step of shifting further comprises the step of:
shifting said common window by a fractional window length.

6. The method according to claim 1, wherein said step of performing is repeated a plurality of times on said given portion of said respective signal data streams, within said common window.

7. The method according to claim 1, wherein said common window has a constant window size.

8. The method according to claim 1, wherein said respective signal data streams comprise symbols therein.

9. The method according to claim 1, further comprising the step of:
determining, at the end of said common window, at least one symbol within at least one of said respective signal data streams, said at least one symbol extending outside said common window, wherein, in said step of performing, said IC process processes said at least one symbol.

10. An interference cancellation apparatus in a telecommunication system, said apparatus comprising:
receiving means for receiving signals from at least two users, said received signals forming respective signal data streams; and
performing means for performing an interference cancellation (IC) process on a given portion of each of said signal data streams, each said given portion being within a common window, whereby respective interference between each of said respective signal data streams is minimized.

11. The apparatus according to claim 10, further comprising shifting means for shifting, upon completion of said performing means, said common window to another portion of said signal data streams.

12. The apparatus according to claim 11, wherein said shifting means shifts said common window by a full window length.

13. The apparatus according to claim 11, wherein said shifting means shifts said common window by a fractional window length.

14. The apparatus according to claim 10, wherein said performing means further comprises repeating means for repeating said IC process a plurality of times on said given portion of said respective signal data streams, within said common window.

15. The apparatus according to claim 10, wherein said common window has a given window size, said apparatus further comprising modifying means for modifying said given window size.

16. The apparatus according to claim 10, wherein said respective signal data streams comprise symbols therein.

17. The apparatus according to claim 10, further comprising:
determining means for determining, at the end of said common window, at least one symbol within at least one signal data stream, said at least one symbol extending outside said common window, wherein said performing means performs said IC process on said at least one symbol.

18. A wireless telecommunications system comprising:
a receiver for receiving signals from at least two users, said received signals forming respective signal data streams; and
a processing unit for performing an Interference Cancellation (IC) process on a given portion of each of said signal data streams, each said given portion being within a common window, whereby respective interference between each of said respective signal data streams is minimized.

19. The system according to claim 18, further comprising a memory unit connected to said receiver for storing said respective signal data streams thereon, said memory unit being coupled to said processing unit.

20. The system according to claim 19, wherein said memory unit comprises a buffer memory, said processing unit performs said IC process on said respective signal data streams in said buffer memory.

21. The system according to claim 18, wherein said processing unit further comprises a repeater for repeating said IC process a plurality of times on the respective given portions of said respective signal data streams within said common window.

22. The system according to claim 18, wherein said processing unit further comprises a shifter for shifting said common window to another portion of said respective signal data streams.

23. The system according to claim 18, further comprising a determiner for determining, at the end of said common window, at least one symbol within said signal data streams, said at least one symbol extending outside said common window, wherein said performing means performs said IC process on said at least one symbol.

24. A memory storage device for storing a data structure therein, said memory storage device comprising:
(a) receiving means for receiving data;
(b) performing means for performing an interference cancellation (IC) process on a portion of said received data, said IC process processing said portion within a window; and
(c) shifting means for shifting said window.

25. The memory storage device according to claim 24, wherein said performing means repeats said IC process on said portion of said received data within said window a plurality of times.

26. The memory storage device according to claim 24, wherein said shifting means shifts said window by a full window length,

27. The memory storage device according to claim 24, wherein said shifting means shifts said window by a partial window length.

28. The memory storage device according to claim 24, wherein said received data comprise symbols therein.

29. The memory storage device according to claim 24, further comprising:
determining means for determining, at the end of said window, at least one symbol within said received data, said at least one symbol extending outside said window, wherein said performing means performs said IC process on said at least one symbol.
